(19) United States
(12) Patent Application Publication
(10) Pub. No.: US 2026/0245782 A1
(43) Pub. Date: Aug. 20, 2026

(54) COIL COMPONENT AND FILTER STAGE

(71) Applicant: TDK Electronics AG, München (DE)

(72) Inventors: Fabian BECK, Rüttenen (CH); Jude HE, Foshan, Guangdong (CN); Zilong KUANG, Zhuhai, Guangdong (CN)

(21) Appl. No.: 18/872,088

(22) PCT Filed: Jun. 14, 2023
(86) PCT No.: PCT/EP2023/065983

§ 371 Date: Dec. 5, 2024

(30) Foreign Application Priority Data
Jun. 29, 2022 (DE) 10 2022 116 181.1

(51) Int. Cl. H01F 27/02; H01F 27/22; H01F 27/28

(52) U.S. Cl. CPC H01F 27/025; H01F 27/22; H01F 27/2847; H01F 2027/2857

(57) ABSTRACT

An improved coil component for an improved filter stage is provided. The coil component comprises a shell and a first coil arranged in the shell. The first coil is thermally coupled to the shell and the shell has an external surface provided and configured to conduct heat to an external environment.

The present invention refers to a coil component that may be used in a filter stage and a corresponding filter stage. The coil component and the filter stage may be used between a battery and an inverter, e.g. in an electric vehicle.

Batteries can be provided as a source of electric power in a variety of operating voltages. However, when electric power is used in a form other than being directly provided from the battery, e.g. when an AC power is needed instead of a DC power or when a different voltage is needed, then inverters may be used to convert the electric power stored in the battery to a form of electric power needed by a load, e.g. an electric motor.

However, inverters may work with semiconductor switches and the operation of an inverter may cause unwanted frequency components that need to be filtered.

However, the filtering of unwanted frequency components such as common mode signals and the corresponding dissipation of the energy leads to temperature increases in the corresponding filter components.

Thus, what is needed is an improved way of filtering unwanted frequency components.

To that end, a coil component according to independent claim 1 is provided. Dependent claims provide preferred embodiments and a corresponding filter stage.

The coil component comprises a shell. Further, the coil component comprises a first coil arranged in the shell. The first coil is thermally coupled to the shell. The shell has an external surface provided and configured to conduct heat to an external environment.

The shell establishes a housing specifically provided for the first coil. However, the coil component including the shell as a housing for the coil and the coil may be integrated in a further environment including a housing containing additional elements to the coil component.

The shell can have one or a plurality of external surfaces each of which can be used to conduct heat to the external environment. The external environment can be an environment of a filter stage or of an electric vehicle or of a housing of an inverter or a housing of a battery or a DC link component electrically and mechanically connecting or coupling a battery and an inverter.

The provision of the shell as a heat conducting element between the first coil and the environment, specifically the provision of the shell as a heat bridge to the environment, helps to maintain the first coil at a tolerable temperature level such that the first coil can efficiently and effectively contribute to filtering unwanted frequency components, e.g. of common mode signals that may originate in an inverter.

In particular, the provision of the coil component comprising the shell as the heat bridge between the coil and the external environment establishes the possibility of a high integration level as the coil component can be provided with small spatial dimensions but simultaneously provides good electric performance.

It is possible that the coil component, specifically the first coil, comprises a first coil part and a second coil part. The second coil part can be electrically and/or magnetically coupled to the first coil.

The first coil part and the second coil part can be magnetically coupled to the same conducting structures, e.g. power conducting lines coupled between a battery and an inverter.

The first coil part and the second coil part may be electrically connected or electrically isolated from one another. However, the first coil and the second coil contribute together to filter unwanted frequency components.

It is possible that the second coil part is also thermally coupled to the shell. Thus, the shell also provides a heat bridge for conducting heat from the second coil part to the external environment.

It is possible that the first coil part and/or the second coil part is mechanically pressed against an interior surface of the shell or glued to the interior surface of the shell, e.g. via a thermally conductive glue, or is soldered or welded to the interior surface of the shell.

However, further mechanical connection possibilities for thermally coupling the first or the second coil part to the shell are also possible.

It is possible that the first and/or second coil part comprises or consists of a wound tape.

The (magnetic) tape can be a tape having a thickness of 10 μm or more and 0.2 mm or less, a width of 5 mm or more and 10 cm or less and a length between 10 cm and 1 m.

It is possible that the material of the first and/or second coil part comprises or consists of a material selected from nano-crystalline material, a MnZn ferrite and a NiZn ferrite, a combination of a nano-crystalline material and a MnZn ferrite.

However, other materials that provide the preferred magnetic coupling to the conducting structures of which unwanted frequency components are to be filtered are possible too.

It is possible that first and/or second coil part has a round or oval shape.

A round or oval shape has the advantage that the coil can be provided as a wound sheet material wound around a center and integrated in the shell and mechanically and thermally coupled to a material surface of the shell.

It is possible that the shell comprises or consists of a material selected from aluminium (Al), copper (Cu), silver (Ag), a combination of Al and a plastic, partially Al and partially a plastic and a carbon based material such as graphite or graphene.

However, any conducting or dielectric material providing a high heat conductivity, e.g. a heat conductivity of 1 W/mK or higher is also possible.

It is possible that the shell has an essentially cuboid shape. The shape can have four rounded edges. Further, the cuboid shape can have spatial dimensions L, H, W with 5 mm≤L≤10 cm; 1 cm≤H≤10 cm; 1 cm≤W≤10 cm.

Specifically, it is possible that the cuboid shape has a quadratic footprint with 1 cm≤H=W≤7 cm.

Such a shape, with the corresponding spatial dimensions, provides a coil component that can be integrated at a high integration level into an external environment while providing sufficient heat conductivity to dissipate heat from the first and/or second coil part to the external environment such that optimal operation conditions for the coils are maintained.

It is possible that the shell has an inner thermal conduction structure. The inner thermal conduction structure of the shell can include a ring arranged orthogonal to a longitudinal extension direction z. An inner surface of the ring can be thermally coupled to the first and/or second coil part. The ring can be connected to an inner side of outer walls of the shell.

Specifically, the ring can be directly attached to outer walls of the shell at a top or bottom flat surface of the ring and connected to another inner side of outer walls at one, two, three, four or more connection points.

Specifically, it is possible that the shell has one such ring for each coil of the coil component.

It is possible that the shell comprises two or more segments arranged in series in the longitudinal extension direction z. The two segments are electrically and/or magnetically isolated from one another.

It is possible that the shell comprises a gap filled with air or a dielectric material, while the gap separates the two segments.

It is possible that the shell comprises heat fins, a surface provided and configured to be connected to a heat sink and/or a cooling fan at an outer surface.

Via the heat fins, the shell can dissipate heat to an external environment, e.g. air, to maintain the coils for filtering at an appropriate temperature level. Via the surface, heat can be conducted to an external mounting area, e.g. a housing of an inverter, of a battery or of a DC link between the battery and the inverter or the chassis of an electric vehicle.

Further, a cooling fan can increase the heat flow, e.g. to heat fins of the coil component to further increase heat dissipation.

A corresponding filter stage can comprise inductance elements and/or capacitance elements. It is possible that at least one inductance element is realized by a coil component as described above. Specifically, it is possible that the filter stage is provided and adapted to be connected between a battery and an inverter, e.g. of an electric vehicle.

Working principles and details of preferred embodiments are shown in the accompanying schematic figures.

In the figures:

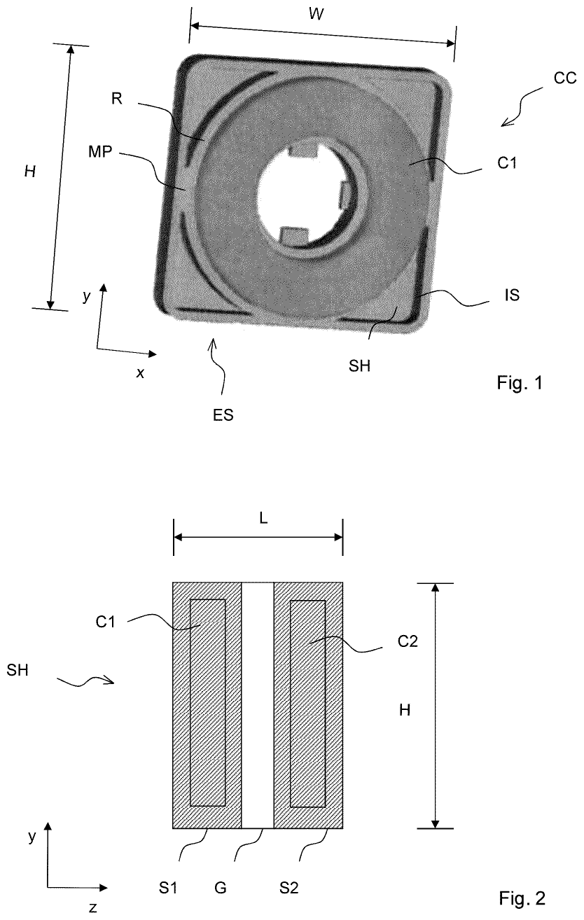

FIG. 1 shows a perspective view on components of a coil component.

FIG. 2 illustrates the use of two coils within the shell.

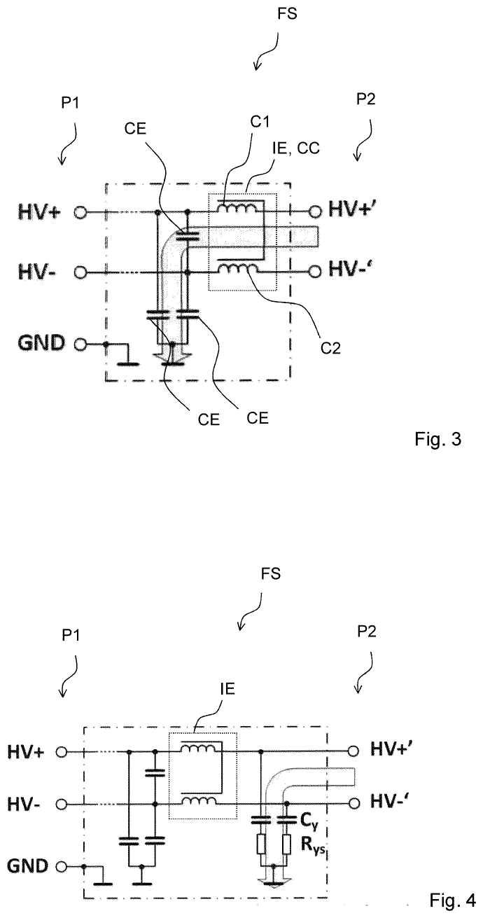

FIG. 3 illustrates the use of the coil component in a filter stage.

FIG. 4 illustrates another circuit topology of a possible filter stage.

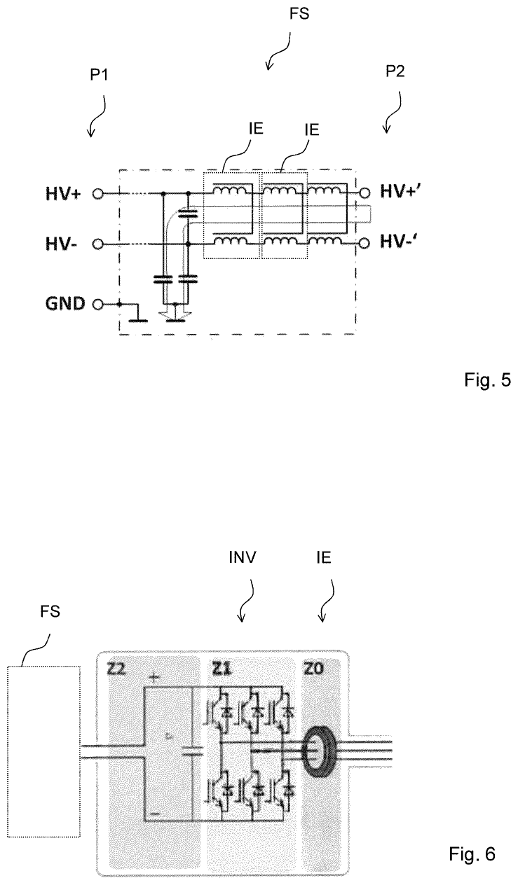

FIG. 5 illustrates another possible filter stage topology.

FIG. 6 illustrates a possible arrangement of semiconductor switched in an inverter.

FIG. 1 shows a perspective view onto elements of the coil component CC. The coil component CC has a first coil C1 integrated in the shell SH acting as a housing and thermal bridge for the first coil C1. The shell SH has external surfaces ES and inner sides IS. Further, the shell has an inner construction including a ring R that in thermal contact with the first coil C1 and with external surfaces ES via mounting points MP. Further, the ring R is in full contact at its one planar surface with an inner side of the shell SH. During operation of the first coil C1 in a filter stage, dissipating electric energy of unwanted frequency components into heat leads to a temperature increase of the first coil C1. However, the shell SH couples the first coil C1 to an external environment in an efficient manner such that optimal operation parameters, specifically optimal temperature parameters of the first coils C1, can be maintained.

The shell SH has an essentially cuboid shape with four rounded edges and the first coil C1 has its windings arranged essentially orthogonal to the longitudinal extension direction z that is orthogonal to the lateral directions x and y. Along the longitudinal extension directions further coils such as a second coil part, a third coil and further coils can be arranged in parallel to the first coil along the longitudinal extension direction z.

FIG. 2 illustrates the use of a first coil C1 in addition to a second coil part C2 that are arranged next to one another in the longitudinal extension direction z and contained within the shell SH. Further, the shell SH comprises a first segment S1 and a second segment S2 that are separated via a gap. The gap can comprise air or a dielectric material. The gap provides a magnetic decoupling between the first segment S1 and the second segment S2 and between the first coil C1 and the second coil part C2.

FIG. 3 illustrates a possible use of the coil component CC establishing an inductance element IE in a filter stage FS between a first port P1 and a second port P2. One of the first and the second port can be electrically connected to a battery while the respective other port can be electrically connected to an inverter. Specifically, the first port P1 can be connected to a battery while the second port P2 can be connected to an inverter. Each port has a first connection to be connected to the positive electrode (HV+) and a second connection to be connected to the negative connection (HV−).

Correspondingly, the coil component comprises a first coil C1 and a second coil part C2 that are magnetically coupled. The first coil C1 is electrically connected in series between the corresponding connection of the first port and of the second port. The second coil part is electrically connected between the corresponding connection of the first port P1 and of the second port P2. Further, a capacitance element CE can be electrically connected between the two connections of the first port while the first port and the second port are electrically connected via further capacitance elements CE to a ground potential.

FIG. 4 illustrates a further possible topology of the filter stage FS. In addition to the filter stage FS shown in FIG. 3, the filter stage shown in FIG. 4 comprises a combination of a Y-capacitor and a Y-resistor such that two resistor elements electrically connect the corresponding electrodes of the Y-capacitor to a ground potential.

FIG. 5 illustrates a further circuit topology of the filter stage FS including additional inductance elements IE. In the topology according to FIG. 5 for each of the connections HV+, HV− there are three coils electrically connected in series. It is possible that one pair of coils, two pairs of coils or three pairs of coils are provided in the form of a coil component as described above.

FIG. 6 shows in inverter comprising semiconductor switches and a coil between the inverter and an electric motor. The inverter is arranged between the filter stage fs and the inverter.

The coil component as described above and the filter stage as described above can comprise further coils, windings and structural elements for improved heat conductance towards the environment. Further, the shell of the coil component can comprise openings such that the shell can be mechanically mounted to an external environment via screws or similar mounting methods.

List of reference signs

| | |
|---|---|
| C1, C2: | first, second coil part |
| CC: | coil component |
| CE: | capacitance element |
| ES: | external surface or outer wall of the shell |
| FS: | filter stage |
| G: | gap between segments of the shell |
| H: | height |
| IE: | inductance element |
| INV: | inverter |
| IS: | inner side |
| L: | length |
| MP: | mounting point |
| P1, P2: | first, second port of the filter stage |
| R: | ring |
| S1, S2: | first, second segment of the shell |
| SH: | shell |
| W: | width |
| x, y: | lateral directions |
| z: | longitudinal extension direction |

1-15. (canceled)

16. A coil component, comprising:
a shell having an external surface, the external surface configured to conduct heat to an external environment; and
a first coil, the first coil arranged in and thermally coupled to the shell.

17. The coil component of claim 16, wherein the first coil has a first coil part and a second coil part, the second coil part electrically and/or magnetically coupled to the first coil part.

18. The coil component of claim 17, wherein the second coil part is thermally coupled to the shell.

19. The coil component of claim 16, wherein the first coil has a first coil part and a second coil part, wherein both the first coil part and the second coil part are (i) mechanically pressed against an interior surface of the shell, (ii) glued to the interior surface of the shell via a thermally conductive glue, or (iii) soldered or welded to the interior surface of the shell.

20. The coil component of claim 16, wherein the first coil has a first coil part and a second coil part, and wherein the first coil part and/or the second coil part comprises or consists of a wound tape.

21. The coil component of claim 16, wherein the first coil has a first coil part and a second coil part, and wherein the first coil part and/or the second coil part has a material selected from a nano-crystalline material, a MnZn ferrite, a NiZn ferrite, a MnZn ferrite, and any combination thereof.

22. The coil component of claim 16, wherein the first coil has a first coil part and a second coil part, and wherein the first coil part and/or the second coil part has a round or oval shape.

23. The coil component of claim 16, wherein the shell comprises or consists of a material selected from aluminum (Al), copper (Cu), silver (Ag), a combination of Al and a plastic, and a carbon-based material such as graphite or graphene.

24. The coil component of claim 16, wherein the shell has a generally cuboid shape with rounded edges, the cuboid shape having dimensions: length (L), height (H), width (W), and wherein the dimensions are: about 5 mm≤L≤about 10 cm, about 1 cm≤H≤about 10 cm, and about 1 cm≤W≤about 10 cm.

25. The coil component of claim 24, wherein both H and W are of equal values.

26. The coil component of claim 16, wherein
(i) the shell has an inner thermal conduction structure including a ring arranged orthogonal to a longitudinal extension direction z,
(ii) an inner surface of the ring is thermally coupled to the first coil, and
(iii) the ring is connected to an inner side of outer walls of the shell.

27. The coil component of claim 16, wherein the shell comprises two segments arranged in series in a longitudinal extension direction z, and wherein the two segments are electrically and/or magnetically isolated from one another.

28. The coil component of claim 27, wherein the shell defines a gap that separates the two segments, and wherein the gap is filled with a material selected from air, a dielectric material, and/or a magnetic material.

29. The coil component of claim 27, wherein the shell includes one or more heat fins, and wherein each of the one or more heat fins has an exterior surface configured to be connected to a heat sink and/or a cooling fan.

30. The coil component of claim 16, in combination with a capacitance element, the coil component forming an inductance element, the combination of the capacitance element and the inductance element forming a filter stage adapted to be connected between a battery and an inverter.

31. The combination of claim 30, further including additional inductance elements.

32. The coil component of claim 18, wherein both the first coil part and the second coil part are (i) mechanically pressed against an interior surface of the shell, (ii) glued to the interior surface of the shell via a thermally conductive glue, or (iii) soldered or welded to the interior surface of the shell.

33. The coil component of claim 18, wherein the first coil part and/or the second coil part comprises or consists of a wound tape.

34. The coil component of claim 18, wherein
(i) the shell has an inner thermal conduction structure including a ring arranged orthogonal to a longitudinal extension direction z,
(ii) an inner surface of the ring is thermally coupled to the first coil, and
(iii) the ring is connected to an inner side of outer walls of the shell.

35. The coil component of claim 18, wherein the shell comprises two segments arranged in series in a longitudinal extension direction z, and wherein the two segments are electrically and/or magnetically isolated from one another.
